(19) United States
(12) Patent Application Publication
(10) Pub. No.: US 2004/0213972 A1
(43) Pub. Date: Oct. 28, 2004

(54) Stencil printing master and production process therefor

(76) Inventors: Hideyuki Kinoshita, Ibaraki-ken (JP); Yasuo Yamamoto, Ibaraki-ken (JP); Tsutomu Nio, Ibaraki-ken (JP); Toru Nakai, Saitama-ken (JP); Yuichi Ogawa, Hyougo-ken (JP)

Correspondence Address: NATH & ASSOCIATES, 1030 15th STREET, 6TH FLOOR, WASHINGTON, DC, 20005, US

(21) Appl. No.: 10/829,230

(22) Filed: Apr. 22, 2004

(30) Foreign Application Priority Data
Apr. 28, 2003 (JP) P2003-123851

(51) Int. Cl. B32B 3/00

(52) U.S. Cl. 428/211.1

(57) ABSTRACT

A stencil printing master is provided that includes a porous fiber layer, and a porous resin layer formed on one surface of the porous fiber layer. The porous resin layer includes a thermoplastic resin having a ratio (G1/G2) of a storage modulus (G1) at 45° C. to a storage modulus (G2) at 180° C. of 1×10² to 1×10⁴, and a peak melting temperature by DSC of 50° C. to 150° C. There is also provided a process for producing the stencil printing master.

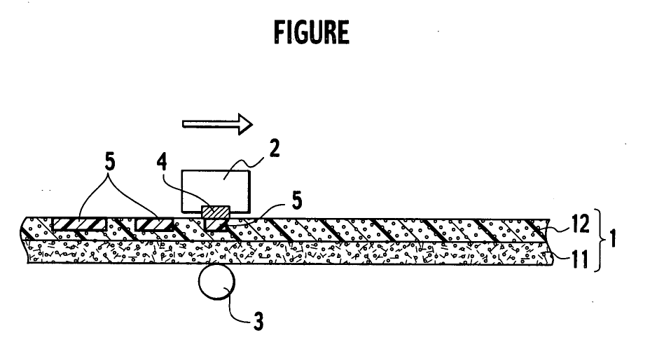

### BACKGROUND OF THE INVENTION

1. Field of the Invention

The present invention relates to a stencil printing master and a production process therefor.

2. Background Art

Conventionally, as a master for stencil printing, a master for heat-sensitive stencil printing (heat-sensitive stencil) in which perforation is carried out by infrared radiation or a thermal head is known, and one formed by bonding, using an adhesive, a thermoplastic film and a porous tissue paper, etc., which serves as a support for the film, is generally used. Furthermore, as a stencil printer employing the heat-sensitive stencil master, a rotary stencil printer and a simple press-type stencil printer are well known. In these printers, ink that has been forced through from the master support side is transferred to a printing paper through holes formed in the film so as to correspond to the image area of an image that is to be printed, thus carrying out printing.

In the conventional stencil printing, since the ink, which is forced through from the support side, is highly viscous and it takes a long time to penetrate into the printing paper, there is the problem that when printed material is handled immediately after printing, fingers, etc. are stained, and there is also the problem that, when printing is carried out continuously for a second or subsequent color in multicolor printing or for the reverse side in double-sided printing, incompletely dried ink on the printed paper is transferred to a rubber roller, etc. of the printer, and the ink thus transferred is further transferred to the following printing paper, thus staining the printed material. In order to carry out drying adequately, it is therefore necessary to wait for a certain period of time (for example, about 10 to 20 minutes) before moving on to the following step.

In order to improve the drying of an ink, improving the penetration of the ink into a printing paper by using a low viscosity ink is effective. There are known, as masters for such a low viscosity ink, a stencil printing plate in which a plate pattern is formed by selectively sealing pores of a porous substance having an average pore size of 30 μm or less by making an ink penetrate (Japanese Unexamined Patent Laid-open No. 9-48105), and a stencil printing master made of an inelastic resin film and having an air permeability of 1 to 600 sec and a thickness of 1 to 100 μm, which is used for stencil printing employing an ink having a low viscosity of 0.001 to 1 Pa·s (Japanese Unexamined Patent Laid-open No. 2002-2140).

### SUMMARY OF THE INVENTION

The present inventors have developed a stencil printing master comprising a porous support and a porous resin layer formed on one surface of the porous support, a platemaking process therefor, and a stencil printing process. In accordance with one aspect of this stencil printing master, platemaking is carried out by blocking an area of the porous resin layer, corresponding to an area through which the ink should not pass, by melting with the heat of a thermal head, etc. However, in this platemaking process, if blocking of a pore of the porous resin layer is incomplete, the ink will pass through the pore, thus forming a black spot in a white area of the printed material (hereinafter, this is called a ‘pinhole’).

In order to avoid the occurrence of such a phenomenon, the energy input into the thermal head can be increased so as to increase the temperature of the heat generated by the thermal head and make the porous resin layer easy to melt, but the heat of the thermal head also melts the porous resin layer in an area where pores are supposed to remain as an image area, and as a result characters and lines become illegible when printed.

It may also be possible to increase the melting point of a resin contained in the porous resin layer so as to reduce susceptibility to the heat of the thermal head, but this cannot suppress the pinholes. Even if the pinholes could be suppressed, the energy input into the thermal head increases, and the durability of the thermal head is affected. On the other hand, by lowering the melting point of the resin in the porous resin layer, the energy input into the thermal head can be decreased and the susceptibility to the heat of the thermal head can be reduced, but in this case, stencil printing masters processed into a roll form might stick to each other in a high temperature environment, or the porous resin layer might peel off from a porous support.

One aspect of the present invention therefore relates to a stencil printing master comprising a porous fiber layer and a porous resin layer formed on one surface of the porous fiber layer, the porous resin layer containing a thermoplastic resin having a ratio (G1/G2) of a storage modulus (G1) at 45° C. to a storage modulus (G2) at 180° C. of 1×10² to 1×10⁴, and a peak melting temperature by DSC of 50° C. to 150° C.

Another aspect of the present invention relates to a process for producing a stencil printing master according to the above aspect of the present invention, the process comprising:

(1) preparing a coating solution containing a thermoplastic resin having a ratio (G1/G2) of a storage modulus (G1) at 45° C. to a storage modulus (G2) at 180° C. of 1×10² to 1×10⁴, and a peak melting temperature by DSC of 50° C. to 150° C.; (2) introducing air bubbles into the coating solution by a mechanical stirring method; and (3) coating one surface of a porous fiber layer with the air bubble-containing coating solution so as to form a porous resin layer.

### BRIEF DESCRIPTION OF THE DRAWINGS

Figure is a schematic cross-sectional view showing, as one example of the platemaking process, a state in which a plate is being made from a master by thermal melting using a thermal head.

### DETAILED DESCRIPTION OF PREFERRED EMBODIMENTS

The stencil printing master (hereinafter, simply called a ‘master’) related to the present invention includes a porous fiber layer and a porous resin layer formed on one surface of the porous fiber layer.

Examples of the porous fiber layer include papers such as tissue paper and coated paper containing cellulose as a main component, machine-made papers in which a synthetic fiber such as a polyester fiber is mixed, and fabrics such as woven fabric and nonwoven fabric. Among these examples, paper containing as a main component a pulp (including mechanical pulp, chemical pulp, and semi-chemical pulp) originating from the wood of a softwood, a hardwood, etc. can be used preferably. In this case, it is preferable for the paper to contain at least 50 wt % (mass %) of pulp originating from wood. In particular, it preferably contains pulp originating from a hardwood in order to improve the surface smoothness of the paper. Conventionally, a tissue paper, etc. formed from as a main starting material a bast fiber such as Paper Mulberry, Mitsumata, or hemp has been used as the porous fiber layer of the master. However, if a paper containing as a main component wood-derived pulp is used as the porous fiber layer, there are fewer voids on the surface of the porous fiber layer than is the case conventionally, and since there is less sinking into the porous fiber layer of the air bubble-containing coating material (coating solution) for formation of the porous resin layer, it is therefore possible to form the resin layer on the surface of the master without unevenness. Therefore, when making a plate by means of a thermal head, inadequate heat transfer due to the unevenness can be avoided, and few defective plates are made.

With regard to the properties required for the porous fiber layer in the present invention, in addition to the strength as a film support, there is also the surface having few voids, the air bubble-containing coating material not easily sinking into the porous fiber layer when the coating solution is applied, sufficient ink being retained in the porous fiber layer, the ink being able to pass easily through the porous fiber layer, the ink being able to be supplied smoothly to the porous resin layer, the surface having little unevenness, blocking of pores on the surface of the porous resin layer not being affected, etc.

It is therefore preferable for the density of the porous fiber layer to be in the range of 0.5 to 1 g/cm³, for the air permeability to be in the range of 3 to 100 sec, and for the surface roughness Ra to be in the range of 1 to 4 μm. More preferably, the density is 0.6 to 0.9 g/cm³, the air permeability is 3 to 50 sec, and the surface roughness Ra is 1.2 to 3 μm.

The basis weight of the porous fiber layer is not particularly limited as long as there is no jamming of the master in a printer, and creases do not occur in the master when wrapping it around a printing drum, but in order to retain a sufficient amount of ink it is preferably at least 30 g/m². On the other hand, from the viewpoint of ink consumption when ejecting the plate, the basis weight of the porous fiber layer is preferably 130 g/m² or less, more preferably 90 g/m² or less, and yet more preferably 70 g/m² or less.

The porous fiber layer having these properties can retain a low viscosity ink having a viscosity of 0.001 to 1 Pa·s and can supply the ink smoothly to the porous resin layer.

Examples of resins that can be used for formation of the porous resin layer include polyvinyl alcohols having various molecular weights and degrees of saponification, and derivatives thereof; cellulose derivatives such as methoxy cellulose, carboxymethyl cellulose, methyl cellulose, and ethyl cellulose; water-soluble resins such as sodium polyacrylate, polyvinylpyrrolidone, acrylamide-acrylic ester copolymers, acrylamide-acrylic ester-methacrylic ester copolymers, alkali salts of styrene-maleic anhydride copolymers, polyacrylamide and derivatives thereof, and polyethylene glycol; polyolefins such as polyethylene; ionomers such as ethylene-methacrylic acid copolymers; and water-dispersible resins such as polyvinyl acetate, polyurethane, urethane-acrylic copolymers, styrene-butadiene copolymers (SBR latex), acrylonitrile-butadiene copolymers (NBR latex), methyl methacrylate-butadiene copolymers (MBR latex), polyacrylate esters, polymethacrylic esters, acrylic ester-styrene copolymers, polyvinyl acetate, vinyl chloride-vinyl acetate copolymers, ethylene-vinyl acetate copolymers, styrene-butadiene-acrylic copolymers, and polyvinylidene chloride, but they are not limited thereto. These resins can be used singly or in a combination of two or more types as necessary.

It is preferable for the porous resin layer to be composed substantially of a thermoplastic resin in order to enable pores to be blocked by thermal melting using a thermal head, etc. That is, the porous resin layer can contain a non-thermoplastic resin in an amount such that thermal melting and ink penetration will not be hindered.

In the present invention, the porous resin layer contains a thermoplastic resin having a ratio (G1/G2) of a storage modulus (G1) at 45° C. to a storage modulus (G2) at 180° C. of 1×10² to 1×10⁴, and a peak melting temperature by DSC of 50° C. to 150° C. This thermoplastic resin is preferably the main component among the resins contained, that is, it has the greatest content (weight) among the constituent resins. Furthermore, the content of this thermoplastic resin is preferably at least 70 wt % of the total resin content, more preferably at least 80 wt %, and yet more preferably at least 90 wt %. Moreover, the solids content of thermoplastic resin is preferably at least 60 wt % of the porous resin layer, more preferably at least 70 wt %, and yet more preferably at least 80 wt %. Two or more types of the thermoplastic resins having the above-mentioned two properties can be contained, and in this case the total content of these types of thermoplastic resins is preferably in the above-mentioned range.

The above-mentioned thermoplastic resins have a melting point of 50° C. to 150° C. When the melting point is 50° C. or higher, undesirable adhesion of the masters can be prevented. On the other hand, if the melting point exceeds 150° C., when a thermal head is used for platemaking by thermal melting, it is necessary to increase the energy input to the thermal head in order to increase the temperature of the heat generated by the thermal head, and this might affect the durability of the thermal head in some cases. The melting point is more preferably in the range of 50° C. to 100° C. The melting point referred to here is the peak melting temperature by DSC.

The storage modulus (G1) at 45° C. of the above-mentioned thermoplastic resins is the storage modulus when the thermoplastic resins used in the present invention are not melted, and the storage modulus (G2) at 180° C. is the storage modulus after the thermoplastic resins have melted completely. When the storage modulus ratio (G1/G2) is less than 1×10², since the thermal flowability is low, pores cannot be completely blocked by the thermal head, and pinholes occur when printing. Even if pores could be blocked, it would be necessary to increase the energy input into the thermal head, and the durability of the thermal head would be affected. On the other hand, when the storage modulus ratio (G1/G2) exceeds 1×10⁴, the thermal flowability of the resin is too high, the energy for blocking pores by the thermal head will melt the resin in an image area, and characters and lines are broken up when printing and cannot be identified as the characters and lines.

As the thermoplastic resin having the above-mentioned melting point and storage modulus characteristics, one or more types chosen from ionomers such as an ethylene-methacrylic acid copolymer (e.g., an ethylene ionomer) and olefin resins can be used particularly preferably.

As the base polymer of the ionomer, for example, an ethylene-unsaturated carboxylic acid copolymer is preferably used, and as this unsaturated carboxylic acid, acrylic acid or methacrylic acid is preferably used. With regard to a preferred composition of such a copolymer, ethylene is 30 to 90 wt %, and the unsaturated carboxylic acid is 70 to 10 wt %. This ethylene-unsaturated carboxylic acid copolymer may further copolymerized with a small amount of another polymerizable monomer such as a (meth)acrylate ester. Examples of a metal ion in the ionomer include alkali metal ions such as lithium, sodium, potassium, and cesium, divalent ions such as magnesium, calcium, and zinc, and trivalent ions such as aluminum. Instead of the metal ion an ammonium ion can be used. The degree of neutralization of these ions in the ionomers may be 10 mol % to 80 mol % as necessary.

Preferred examples of the olefin resin include olefin-acrylic copolymer resins (olefin-(meth)acrylic ester copolymers or olefin-(meth)acrylic acid copolymers). With regard to preferred compositions of the olefin-(meth)acrylic ester copolymers or olefin-(meth)acrylic acid copolymer, the olef in component is 30 to 90 wt % and the acid or ester component is 70 to 10 wt %. Examples of the olefin include ethylene, propylene, butene-1, isobutylene, pentene, heptene, octene, and mixtures thereof; among these, C1 to C4 a-olefins are preferable, and ethylene is particularly preferable. Examples of the (meth)acrylic esters include C1 to C12 alkyl (meth)acrylates such as methyl acrylate, ethyl acrylate, t-butyl acrylate, n-butyl acrylate, 2-ethylhexyl acrylate, methyl methacrylate, and ethyl methacrylate, and mixtures thereof. Furthermore, when a functional group is a carboxyl group, an ionic crosslinking agent such as a metal compound can be used as a crosslinking agent.

With regard to the resin used in the porous resin layer, from the viewpoint of fine line reproduction, it is preferable to use only a thermoplastic resin having the above-mentioned two properties, but when such a resin is used in combination with another resin, the melting energy of the thermoplastic resin having the above-mentioned two properties (when a plurality of such thermoplastic resins are used, the total melting energy thereof) is preferably at least 70% of the total melting energy obtained by measuring all the resins, and more preferably at least 80%. If the melting energy of the thermoplastic resin (when a plurality of types are used, the total melting energy thereof) is less than 70% of the total melting energy, then when blocking pores by the thermal head, etc., areas that are supposed to remain as image areas are also melted by the heat of the thermal head because of the difference in melting point between the thermoplastic resin and the other resins, and characters and lines might not be printed.

In order to improve the uniformity of an image formed by transferring an ink to a printing paper and the reproduction of small characters, the surface roughness (Ra) of the porous resin layer comprising the above-mentioned resins is preferably 4 μm or less. Since this can reduce the surface unevenness of the porous resin layer, a concave area of the surface of the porous resin layer easily makes contact with the printing paper by means of pressure when printing. The surface roughness (Ra) of the porous resin layer can be reduced by, for example, imparting high flowability to the air bubble-containing coating material for formation of the porous resin layer, using a porous fiber layer having high smoothness, or making the pores on the surface of the porous resin smaller.

The average pore size of the pores on the surface of the porous resin layer is preferably at least 2 μm from the viewpoint of ink penetration, the uniformity of solid printed areas, and the reproduction of small characters, and is preferably at most 10 μm from the viewpoint of ensuring the blockage of pores and controlling the amount of ink transferred. If the pores are too large and exceed the above-mentioned preferred range, when a plate is made by thermal melting, some areas in which pores cannot be blocked start to be produced, the ink tends to pass through these areas and be transferred as a pinhole to an area of the printed material that is supposed to be white background. Moreover, the amount of ink passing through is excessive, and the printed image tends to spread and appear blurred. On the other hand, when the pores are too small, areas in which the pores in the porous resin layer are not continuous increase, and it becomes difficult for the ink to pass through the layer, which is undesirable.

The proportion of the porous resin layer occupied by pores is preferably at least 30% from the viewpoint of the reproduction of small characters, the uniformity of solid printed areas, and the overall density, and is preferably at most 90% from the viewpoint of the strength of the porous resin layer, and more preferably 40% to 80%. When the proportion of the layer occupied by pores exceeds the above-mentioned range, which is undesirable, there is the possibility that the porous resin layer might be flattened when making a plate or printing.

The porous resin layer preferably contains a mold-release agent in addition to the above-mentioned resins. The mold-release agent functions in the porous resin layer to prevent the molten resin from adhering to the thermal head, etc., thereby improving the reproduction of small characters. As the mold-release agent, one type or two or more types of silicone-based, fluorine-based, wax-based, or surfactant-based mold-release agent, a silicone phosphate ester, etc. can be used.

Among these, it is preferably to use a silicone-based surfactant, which is not melted by heat, since the image area after platemaking can be maintained reliably. In particular, from the viewpoint of air bubble stability, a silicone-based surfactant having an HLB value of 5 or higher is preferable. A silicone-based surfactant having an HLB value of 9 or higher is more preferable. Silicone-based surfactants are often used as antifoaming agents, and although this can degrade the stability of air bubbles in the air bubble-containing coating solution, enlarge the pores on the surface of the porous resin layer after coating and drying, or destroy the pores and form no through holes, in the case of a silicone-based surfactant having an HLB value of 5 or higher there is almost no degradation of the stability of the air bubbles in the coating solution, and the pores on the surface of the porous resin layer are not enlarged.

The HLB value referred to here means the hydrophilic-lipophilic balance of a nonionic surfactant and can be represented by the following equation.

$$HLB of nonionic surfactant = wt \% of hydrophilic group \times ( 1 \text{/} 5 ) \\ = ( molecular weight of hydrophilic \\ group \text{/} molecular weight of \\ surfactant ) \times ( 100 \text{/} 5 )$$

A nonionic surfactant having a low HLB value is often used as an antifoaming agent, and a nonionic surfactant having a high HLB value is often used as an emulsifier or a detergent. A silicone-based surfactant having a high HLB value has its silicone terminus modified with a hydrophilic group. This silicone-based surfactant having a high HLB value is arranged at the gas-liquid interface and functions as an air bubble-stabilizing agent.

The amount of silicone-based surfactant added is preferably 0.1 to 15 parts by weight as a solids content relative to 100 parts by weight of the solids content of the coating solution, which is of an aqueous dispersion type, is more preferably 1 to 10 parts by weight, and yet more preferably 1 to 5 parts by weight. Even if the amount of silicone-based surfactant added exceeds 15 parts by weight, there is no additional effect, and instead it is economically disadvantageous.

Instead of adding the mold-release agent to the porous resin layer, it is also possible to provide a mold-release layer containing the mold-release agent on the porous resin layer.

The porous resin layer may, if necessary, contain various types of adjuvant as appropriate. Examples of the various types of adjuvant include known pigments, viscosity-adjusting agents, dispersants, colorants, lubricants, crosslinking agents, and plasticizers.

When the structure of a cross section of the master of the present invention comprising the above-mentioned porous fiber layer and porous resin layer is examined using a scanning electron microscope, the pores of the porous resin layer form through holes that communicate through from the surface of the porous fiber layer to the surface of the porous resin layer, and in the porous fiber layer there are a large number of cavities between the fibers. This structure allows the ink to be retained in the porous fiber layer and the porous resin layer and, furthermore, allows the ink to permeate and pass through, and the ink can therefore be transferred to a printing paper.

With regard to the properties of the master, from the viewpoint of appropriate control of the amount of ink passing through, the air permeability of the master is preferably 100 sec or less, more preferably 60 sec or less, and yet more preferably 30 sec or less. When the air permeability of the master is 100 sec or less, it is possible to carry out printing by suppressing to an appropriate level the throughput of the low viscosity ink (0.001 to 1 Pa·s), which has a high speed of penetration into the printing paper, white spots due to an insufficient amount of ink transferring when printing can be prevented from occurring, and the uniformity of solid printed areas and the reproduction of small characters are desirable. On the other hand, if the air permeability of the master is less than 3 sec, the amount of ink retained by the master increases, an excess amount of ink is transferred to the printing paper when printing, and there is the possibility of spreading of the ink, nonuniform density, staining due to incompletely dried ink, etc. It is therefore preferable for the air permeability to be 3 sec or more.

The basis weight of the master is preferably at least 35 g/m² from the viewpoint of the amount of ink retained by the master and preventing creases occurring when the master is wrapped around a printing drum. On the other hand, there is no upper limit to the basis weight of the master, but it is preferably 150 g/m² or less from the viewpoint of the ink consumption when ejecting the plate, more preferably 100 g/m² or less, and yet more preferably 80 g/m² or less.

Furthermore, the compressive modulus of the master is preferably 7 MPa or less. Use of the master having a compressive modulus of 7 MPa or less enables the master to be compressed due to the pressure when printing and the ink retained by the porous fiber layer and the porous resin layer to be forced through the master, thereby increasing the amount of ink transferred, making it easy for the ink to be transferred to a depression on the printing paper surface, and giving a printed material having excellent uniformity of solid printed areas and reproduction of small characters without forming white spots. Furthermore, since the gap between the surface of the porous resin layer and the surface of the printing paper when printing is small, it is possible to prevent excessive transfer of the ink to the gap, thereby giving a printed material having excellent print qualities without causing uneven density in solid printed areas. The compressive modulus of the master can be reduced by, for example, lowering the density of the porous resin layer, using a porous fiber layer having low density, or using a resin having a low compressive modulus as a main component of the porous resin layer.

A method for forming the porous resin layer is not particularly limited, and it can preferably be obtained by coating one surface of the porous fiber layer with a coating solution containing the above-mentioned thermoplastic resin and any other components as necessary, and drying it in a state in which it contains a large number of fine air bubbles formed in the coating solution. The methods and equipment for forming and introducing air bubbles and the coating method are not particularly limited.

More specifically, with regard to a method for forming a porous resin layer on a porous fiber layer, the following methods can be cited as examples. Method (1) in which a porous fiber layer is coated with a coating solution containing a foam, and a gas is generated during or after coating so as to form pores; Method (2) in which a porous fiber layer is precoated with at least one of two or more types of components that generate a gas by coming into contact with each other, and this coated surface is coated with a coating solution containing the rest of the components so as to form a foamed coating; Method (3) in which a porous fiber layer is coated, under normal pressure, with a coating solution that has had a gas dissolved therein at an atmospheric pressure higher than 1 atm, and pores are formed by foaming; and Method (4) in which a porous fiber layer is coated with an air bubble-containing coating solution having a large number of air bubbles formed and dispersed therein by mechanical stirring, and dried. Any of Methods (1) to (4) can be used, but Method (4) is most preferable.

The process for producing the master according to the present invention therefore comprises the following steps:

(1) preparing a coating solution containing the above-mentioned thermoplastic resin;

(2) introducing air bubbles into the coating solution by a mechanical stirring method; and

(3) coating one surface of a porous fiber layer with the air bubble-containing coating solution so as to form a porous resin layer.

The coating solution can be obtained by mixing the above-mentioned resin, the above-mentioned various types of adjuvants as necessary, and an organic solvent for dilution as necessary by a known method.

The amount of coating solution applied is determined appropriately from the viewpoint of the surface smoothness of the porous resin layer obtained, the ink penetration, etc. but, in general, it is preferably in the range of 5 to 40 g/m² on a dry weight basis, and more preferably 8 to 20 g/m². When the amount coated is less than 5 g/m² on a dry weight basis, it tends to be difficult to adequately cover the surface roughness of the porous fiber layer, and a master having an appropriate surface smoothness tends not to be attained. On the other hand, when the dry weight exceeds 40 g/m², the thickness of the porous resin layer tends to be too large, and the ink penetration tends to deteriorate. Furthermore, the bonding strength within the porous resin layer tends to be degraded, scratching and peel off of the coated layer easily occur in normal handling, and adequate strength tends not to be obtained. Moreover, the amount of ink retained increases and the cost is high when ejecting the master.

The state in which the air bubbles are contained in the air bubble-containing coating solution is not particularly limited either, but the ratio by volume of the air bubble-containing liquid relative to the starting liquid (hereinafter, called the ‘foam expansion ratio’) is preferably 1.5 to 10 times, and more preferably 2 to 5 times. The foam expansion ratio referred to here is a scale showing the air bubble content in the air bubble-containing coating solution, and a high foam expansion ratio means that the resin membrane (wall) constituting the air bubbles has a small thickness. For a given foam expansion ratio, the lower the concentration of solids in the coating solution prior to foaming, the thinner the resin membrane. When the resin membrane is thin, it might be difficult to maintain a sufficient strength of the porous resin layer obtained, and it is therefore preferable to set the foam expansion ratio appropriately according to the performance required.

Since the size of the pores is affected by various factors such as the composition of the coating solution prior to formation and dispersion of the air bubbles, that is, the types of component in the mixture and the mixing ratio; foaming conditions such as the foam expansion ratio; the coating method; and the coating conditions, the conditions can be set as appropriate according to the performance required. The smaller the air bubbles in the air bubble-containing coating solution obtained by mechanical stirring, the smaller the pores on the surface of the porous resin layer after coating and drying.

Since the proportion of the porous resin layer occupied by the pores is affected by various factors such as the solids concentration of the coating solution prior to formation and dispersion of the air bubbles, foaming conditions such as the foam expansion ratio, the coating method, the coating conditions, and the size of the pores, the conditions can be set as appropriate according to the performance required. The proportion of the porous resin layer occupied by the pores tends to be higher when the resin solids content of the coating solution is lower, the foam expansion ratio is higher, and the air bubbles in the coating solution are larger.

The foaming method for forming and dispersing air bubbles in the coating solution is not particularly limited and, for example, a foaming machine for confectionery production having a stirrer blade that rotates with a planetary motion, a stirring machine such as a homo-mixer or a Cowles dissolver, which are generally used for emulsification-dispersion, and a continuous foaming machine such as equipment that can carry out mechanical stirring while continuously feeding air and a coating solution into a sealed system, thus dispersing and mixing air as fine air bubbles (e.g., manufactured by Gaston County, USA or Stork, Holland) can be used.

In order to obtain a higher air bubble-containing state by augmenting the performance of the mechanical stirring equipment, or in order to improve the stability of the air bubbles in the air bubble-containing coating solution, etc., additives known as foaming regulators and foaming agents can be added to the coating solution by appropriate selection from a wide range of surface active materials. A surfactant for this purpose can be selected appropriately while taking into consideration the flowability of the coating solution and the ease of the coating operation and, in particular, a higher fatty acid, a modified higher fatty acid, an alkali salt of a higher fatty acid, etc. can be used preferably since the effect of improving the foaming properties of the coating solution and the effect of improving the stability of dispersed air bubbles are high. The amount (solids content) of surfactant added as the foaming regulator or the foaming agent is, in the case of for example an aqueous dispersion type coating solution, preferably 0.5 to 30 parts by weight, and more preferably 1 to 20 parts by weight, relative to 100 parts by weight of the solids content of the coating solution. Even if a large amount of surfactant exceeding 30 parts by weight is used, there is no additional effect and instead it is economically disadvantageous.

The coating system for the coating solution can be selected freely from known methods including a Meyer bar system, a gravure roll system, a roll system, a reverse roll system, a blade system, a knife system, an air-knife system, an extrusion system, and a casting system. In this way, a porous resin layer can be obtained by uniformly coating one surface of the porous fiber layer with the coating solution and then drying.

Platemaking of the master is carried out by blocking pores of the porous resin layer of the master corresponding to non-image areas of the image that it is desired to print, thus forming areas that ink cannot penetrate. The pores that are blocked are those that, among the pores of the porous resin layer of the master, correspond to non-image areas of the image that is to be printed. In order to prevent the ink from penetrating, these pores, which correspond to the non-image areas, are blocked at least on the platemaking surface so that the pores do not pass through from one surface of the plate to the other surface.

The method for blocking the pores is not particularly limited, and examples thereof include a method involving thermal melting, a method involving transfer of a resin or a wax, and a method involving coating with or immersion into a photocurable liquid, followed by curing the liquid so as to block the pores. As the method for blocking the pores of the porous resin layer containing the above-mentioned thermoplastic resin, the method involving thermal melting is most preferable.

That is, the process for producing a plate (that is, a master made into a plate) preferably comprises a step of preparing the master according to the present invention, and a step of blocking the pores of the porous resin layer of the master by thermal melting.

The thermal melting method preferably employs heating means such as a thermal head or irradiation with electromagnetic waves (laser light, etc.). The thermal head can be a line type thermal head or a serial type thermal head. The thermal head resistor may be a thin-film thermal head formed mainly by sputtering or a thick-film thermal head formed by a thick film printing method.

Figure is a schematic diagram showing, as one example of the platemaking method, a state in which platemaking of a master is carried out by thermal melting using a thermal head. A master 1 comprising a porous fiber layer 11 and a porous resin layer 12 is fed to an image formation section formed from a thermal head 2 and a platen roller 3 by means of a feed roller (not illustrated), which can be of any type. A heating element 4 of the thermal head 2 generates heat according to an image signal so as to melt the surface of the master 1 (platemaking surface), thus providing a blocked area 5 (non-image area), in which the pores of the porous resin layer 12 are blocked.

By superimposing the platemaking surface (porous resin layer surface) of the plate thus made on a printing paper, and supplying an ink from the opposite side, that is, the non-platemaking surface side (porous fiber layer side), the ink exudes from the pores (unblocked, corresponding to image areas) of the unprocessed areas of the platemaking surface and is transferred to the printing paper, thus carrying out stencil printing.

The master of the present invention is suitable for stencil printing employing an ink having a viscosity of 0.001 to 1 Pa·s. When an ink having a viscosity of more than 1 Pa·s is used, the ink cannot pass through the porous fiber layer or the porous resin layer in some areas, thereby undesirably forming white spots in solid printed areas of a printed material, and causing patchiness in small characters and making them illegible. On the other hand, when the viscosity of the ink is less than 0.001 Pa·s, it is very difficult to prepare the ink, and problems such as ink leakage within a printer become more noticeable, which is undesirable.

A colorant added to the ink can be a pigment or a dye. There is a possibility that a pigment might cause blockage depending on the average pore size of the porous resin layer, and in this case it is preferable to use a dye. Other components such as a vehicle and an additive for the ink are not particularly limited. Furthermore, the ink is not particularly limited to a W/O type emulsion ink for stencil printing, and an aqueous or oil-based ink for ink jet or for stamping can be used. An oil-based ink is particularly preferable from the viewpoint of drying properties.

The method for supplying the ink to the plate is not particularly limited. For example, a material having interconnected foam cells (for example, natural rubber, a synthetic sponge rubber, or a synthetic resin foam), which can be impregnated with the ink, is immersed in the ink, this is superimposed on the non-platemaking surface of the plate, a printing paper is then superimposed on the platemaking surface, and pressure is applied thereto so as to allow the ink to be transferred to the printing paper, thus carrying out stencil printing.

Specific printing processes are not particularly limited either, and can be a continuous printing process involving wrapping a plate around a printing drum of a known rotary stencil printer and supplying an ink from the interior of the printing drum, or a press printing process employing a simple stencil printer for home use.

Since the master of the present invention is optimized for the thermal flowability and the melting temperature of the resin contained in the porous resin layer, the use thereof enables the ink to be prevented from passing through to non-printing areas, thus preventing from forming pinholes, and enables characters and fine lines to be vividly and clearly printed in printing areas, in which the image areas remain reliably. Furthermore, since the porous resin layer of the master of the present invention is stable in a high-temperature environment, the masters will not stick to each other.

### EXAMPLES

The present invention is explained below in further detail with reference to Examples, but the present invention is not limited to these Examples as long as it does not depart from the spirit and scope of the present invention. For example, as well as those described below, any resolution or type of thermal head can be used, and as well as those described below, any type or formulation of the various types of components such as the mold-release agents can be used.

Platemaking, printing, measurement, and evaluation described in the Examples were carried out by the following methods. Each of the physical properties was measured after allowing a measurement sample to stand in an ISO standard environment (23° C., relative humidity 50%) for 24 hours.

In the description below, ‘parts’ means ‘parts by weight’. For the composition of a pulp, L denotes hardwood, N denotes softwood, B denotes bleached pulp, KP denotes Kraft pulp, which is a chemical pulp, and the numerical values are expressed as mixing ratios (wt %).

(1) Thermal Head Platemaking Method

A prepared master was subjected, in a platemaking machine, to thermal head platemaking by a method involving application of heat to the porous resin layer in non-image areas of the image that was to be printed so as to block the pores of the areas as non-printing areas, and a plate was thus obtained. The platemaking machine used here can be equipped with any type of thermal head, and thermal head drive conditions, platemaking pressure conditions, etc. can be set freely. A corner edge type thermal head for thermal transfer printing having a resolution of 300 dpi was used. The original was a document having a printed area of 25% that consisted of a mixture of 6 to 16 point characters and solid printed areas.

(2) Printing Method

The plate obtained in (1) above was wrapped around a printing drum of a stencil printer (Risograph, registered trademark, manufactured by Riso Kagaku Corporation), and stencil printing was carried out. Except for example 5, printing was carried out using a pigment ink having a viscosity of 0.01 Pa·s, and in Example 5 a dye ink having a viscosity of 0.01 Pa·s was used.

(3) Evaluation of Pore Blocking Properties

The degree of pore blockage in the plate obtained in

(1) above was investigated by SEM and evaluated using the criteria below.

A: Pores were completely blocked; usable.

B: There were a few areas where the pores were not blocked; usable in practice.

C: There were many areas where the pores were not blocked, and ink was transferred to the printing paper in non-printing areas as pinholes; unusable.

(4) Uniformity of Solid Printed Areas

The uniformity of the solid printed areas of the printed materials obtained in (2) above was evaluated using the criteria below by visually examining the solid printed areas of the printed material.

A: No white spots in the solid printed areas; usable.

B: A few white spots in the solid printed areas; usable in practice.

C: White spots apparent in the solid printed areas; unusable.

(5) Reproduction of Small Characters

Reproduction of small characters of the printed materials obtained in (2) above was evaluated using the criteria below by visually examining the character areas of the printed materials.

A: Sharp characters without patchiness; legible.

B: Slight patchiness in characters; legible; usable in practice.

C: Characters patchy and illegible; unusable.

(6) Air Permeability

The air permeability (time in seconds necessary for 100 ml of air to permeate a unit area of paper) of the masters was measured using an Oken type smoothness tester in accordance with J. TAPPI No. 5.

(7) Average Pore Size and Percent Pore Area of the Surface of Porous Resin Layer

A picture of the surface of the porous resin layer of the master was taken using a scanning electron microscope (SEM) or an optical microscope, the outline of pores on the surface was precisely traced on a transparent film by a black pen, etc., and this was scanned by an image analyzer (V10 Image Analyzer, registered trademark, manufactured by Toyobo Co., Ltd.). Since the shape of the pores on the surface of the porous resin layer of the master was not always round, the average pore size was calculated by conversion of the pores into circles based on the area within the outline of the pore obtained by the image analysis. The proportion of the area occupied by the pores (the percent pore area) is the proportion, relative to the whole area of the surface of the master, of the area occupied by open holes due to the pores, and is determined from the following equation.

(Pore area proportion %)

=(Area occupied by open holes due to pores)

/(Whole area of surface of master)×100

(8) Basis Weight

The basis weights (g/m²) of the porous fiber layer and the master were measured in accordance with JIS P8124.

(9) DSC Measurement (Peak Melting Temperature and Melting Energy)

10 mg of a resin was set in a DSC 6200 thermal analysis system manufactured by SII and heated in a flow of nitrogen at a rate of temperature increase of 10° C./min, and the heat absorption behavior accompanying melting of the resin was analyzed by first-order and second-order differentials. The temperature for a peak or a shoulder was determined, and this was defined as the peak melting temperature. When a plurality of types of resins were used, the entirety of the resins used (mixture) was subjected to DSC measurement, the melting energy was determined for each of the melting peaks obtained, and the proportion of the melting energy of the main component resin was determined.

(10) Storage Modulus

The resin used was set in a model DAR-2000 viscometer (manufactured by REOLOG1CA INSTRUMENT AB), heated at a rate of temperature increase of 3° C./min, and the storage modulus was measured at a frequency of 1.0 Hz.

### EXAMPLE 1

A coating solution (1) (solids content 25%, viscosity 2000 mPa·s) containing 100 parts of an ethylene-methacrylic acid copolymer (Chemipearl S75N, manufactured by Mitsui Chemical Co., Ltd.), 10 parts of a higher fatty acid type foaming regulator (SN Foam 200, manufactured by San Nopco Limited), 2 parts of a polyether type viscosity-increasing agent (SN Thickener 612, manufactured by San Nopco Limited), and 5 parts of a polyether-modified silicone oil (mold-release agent) (KF-354L, manufactured by Shin-Etsu Chemical Co., Ltd.) was prepared.

The coating solution (1) thus obtained was subjected to a foaming treatment by mixing and stirring with air at a stirring speed of 1200 rpm using a continuous foaming machine (product name: Turbowhip TW-70, manufactured by Aicosha Mfg. Co., Ltd.) so as to give a foam expansion ratio of 2.5 times. Immediately after the foaming treatment, the air bubble-containing coating solution thus obtained was applied to the surface of a porous fiber layer (pulp composition=LBKP95/NBKP5, smoothness 40 sec, air permeability 6 sec) having a basis weight of 40 g/m² using an applicator bar at a dry coat weight of 10 g/m², and dried to form a porous resin layer, thus giving a master.

This master was subjecting to platemaking using a thermal head, and the plate thus obtained was used in stencil printing using a pigment ink having a viscosity of 0.01 Pa·s.

### EXAMPLE 2

A coating solution (2) (solids content 30%, viscosity 2000 mPa·s) containing 100 parts of an olefin-acrylic copolymer resin (ET-1000, manufactured by Chuo Rika Kogyo Corporation), 10 parts of a higher fatty acid type foaming regulator (the above-mentioned SN Foam 200), 2 parts of a polyether type viscosity-increasing agent (the above-mentioned SN thickener 612), and 5 parts of a polyether-modified silicone oil (the above-mentioned KF-354L) was prepared.

The coating solution (2) thus obtained was subjected to a foaming treatment in the same manner as in Example 1 at a stirring speed of 1000 rpm so as to give a foam expansion ratio of 3 times. Using the same method thereafter as in Example 1, a master was prepared using a porous fiber layer (pulp composition=LBKP95/NBKP5, smoothness 40 sec, air permeability 6 sec) having a basis weight of 60 g/m², and a plate obtained therefrom was evaluated.

### EXAMPLE 3

A coating solution (3) (solids content 30%, viscosity 2000 mPa·s) containing 100 parts of an olefin-acrylic copolymer resin (C0268, Chuo Rika Kogyo Corporation), 10 parts of a higher fatty acid type foaming regulator (the above-mentioned SN Foam 200), 2 parts of a polyether type viscosity-increasing agent (the above-mentioned SN thickener 612), and 5 parts of an alcohol-modified silicone oil (mold-release agent) (SF-8427, manufactured by Dow Corning Toray Silicone Co., Ltd.) was prepared.

The coating solution (3) thus obtained was subjected to a foaming treatment in the same manner as in Example 1 at a stirring speed of 800 rpm so as to give a foam expansion ratio of 3 times. Using the same method thereafter as in Example 1, a master was prepared, and a plate obtained therefrom was evaluated.

### EXAMPLE 4

A coating solution (4) (solids content 30%, viscosity 600 mPa·s) containing 95 parts of an olefin-acrylic copolymer resin (the above-mentioned C0268), 5 parts of a polyvinyl alcohol (PVA-403, manufactured by Kuraray Co., Ltd.), 10 parts of a higher fatty acid type foaming regulator (the above-mentioned SN Foam 200), and 5 parts of an alcohol-modified silicone oil (the above-mentioned SF-8427) was prepared.

The coating solution (4) thus obtained was subjected to a foaming treatment in the same manner as in Example 1 at a stirring speed of 1200 rpm so as to give a foam expansion ratio of 2.5 times. Using the same method thereafter as in Example 1, a master was prepared, and a plate obtained therefrom was evaluated.

### EXAMPLE 5

A coating solution (5) (solids content 30%, viscosity 600 mPa·s) containing 85 parts of an olefin-acrylic copolymer resin (the above-mentioned C0268), 15 parts of a polyvinyl alcohol (the above-mentioned PVA-403), 10 parts of a higher fatty acid type foaming regulator (the above-mentioned SN Foam 200), and 5 parts of an alcohol-modified silicone oil (the above-mentioned SF-8427) was prepared.

The coating solution (5) thus obtained was subjected to a foaming treatment in the same manner as in Example 1 at a stirring speed of 1000 rpm so as to give a foam expansion ratio of 2 times. Using the same method thereafter as in Example 1, a master was prepared, and a plate obtained therefrom was evaluated.

### EXAMPLE 6

A coating solution (6) (solids content 25%, viscosity 600 mpa-s) containing 95 parts of an ethylene-methacrylic acid copolymer (Chemipearl S300, manufactured by Mitsui Chemical Co., Ltd.), 5 parts of a polyvinyl alcohol (the above-mentioned PVA-403), 10 parts of a higher fatty acid type foaming regulator (DC1OOA, manufactured by San Nopco Limited), and 5 parts of an alcohol-modified silicone oil (the above-mentioned SF-8427) was prepared.

The coating solution (6) thus obtained was subjected to a foaming treatment in the same manner as in Example 1 at a stirring speed of 500 rpm so as to give a foam expansion ratio of 3 times. Using the same method thereafter as in Example 1, a master was prepared, and a plate obtained therefrom was evaluated.

### EXAMPLE 7

The coating solution (1) above was subjected to a foaming treatment in the same manner as in Example 1 at a stirring speed of 100 rpm so as to give a foam expansion ratio of 3 times. Using the same method thereafter as in Example 1, a master was prepared, and a plate obtained therefrom was evaluated.

### EXAMPLE 8

The coating solution (1) above was subjected to a foaming treatment in the same manner as in Example 1 at a stirring speed of 1200 rpm so as to give a foam expansion ratio of 3 times. A porous fiber layer (pulp composition =LBKP100, smoothness 80 sec, air permeability 100 sec) having a basis weight of 207 g/m² was used, and using the same method thereafter as in Example 1, a master was prepared and a plate obtained therefrom was evaluated.

### COMPARATIVE EXAMPLE 1

A coating solution (7) (solids content 25%, viscosity 2500 mPa·s) containing 100 parts of a polyvinyl alcohol (PVA-205, manufactured by Kuraray Co., Ltd.), 10 parts of a higher fatty acid type foaming regulator (the above-mentioned SN Foam 200), and 5 parts of an alcohol-modified silicone oil (the above-mentioned SF-8427) was prepared.

The coating solution (7) thus obtained was subjected to a foaming treatment in the same manner as in Example 1 at a stirring speed of 600 rpm so as to give a foam expansion ratio of 2.5 times. Using the same method thereafter as in Example 1, a master was prepared, and a plate obtained therefrom was evaluated.

### COMPARATIVE EXAMPLE 2

A coating solution (8) (solids content 25%, viscosity 2500 mPa·s) containing 100 parts of a polyvinyl alcohol (R-1130, manufactured by Kuraray Co., Ltd.), 10 parts of a higher fatty acid type foaming regulator (the above-mentioned SN Foam 200), and 5 parts of an alcohol-modified silicone oil (the above-mentioned SF-8427) was prepared.

The coating solution (8) thus obtained was subjected to a foaming treatment in the same manner as in Example 1 at a stirring speed of 600 rpm so as to give a foam expansion ratio of 2.5 times. Using the same method thereafter as in Example 1, a master was prepared, and a plate obtained therefrom was evaluated.

### COMPARATIVE EXAMPLE 3

A coating solution (9) (solids content 25%, viscosity 3500 mPa·s) containing 80 parts of a polyethylene resin (PEM-17, manufactured by San Nopco Limited), 20 parts of a polyvinyl alcohol (the above-mentioned PVA-205), 10 parts of a higher fatty acid type foaming regulator (the above-mentioned SN Foam 200), and 5 parts of a polyether-modified silicone oil (the above-mentioned KF-354L) was prepared.

The coating solution (9) thus obtained was subjected to a foaming treatment in the same manner as in Example 1 at a stirring speed of 1200 rpm so as to give a foam expansion ratio of 3 times. Using the same method thereafter as in Example 1, a master was prepared, and a plate obtained therefrom was evaluated.

The thermal properties of the resins used in the Examples and Comparative Examples described above are summarized in Table 1, and the physical properties, the platemaking properties and the printing performance of the masters obtained are summarized in Table 2.

TABLE 1
Thermal Properties of Resin Constituents

| | Proportion in | Storage modulus | | | Melting | Melting energy |
|---|---|---|---|---|---|---|
| Type (Tradename) | resin (wt %) | 45° C.(G1) | 180° C.(G2) | G1/G2 | point (° C.) | ratio (%) |

| | | | | | | | |
|---|---|---|---|---|---|---|---|
| Ex. 1 | Chemipearl S75N | 100 | 2.28 × 10⁶ | 7.31 × 10² | 3.12 × 10³ | 60 | 100 |
| Ex. 7 | | 100 | | | | | 100 |
| Ex. 8 | | 100 | | | | | 100 |
| Ex. 2 | ET-1000 | 100 | 7.50 × 10⁶ | 6.6 × 10⁴ | 1.14 × 10² | 80 | 100 |
| Ex. 3 | C0268 | 100 | 4.92 × 10⁶ | 1.98 × 10⁴ | 2.49 × 10² | 75 | 100 |
| Ex. 4 | | 95 | | | | | 97 |
| Ex. 5 | | 85 | | | | | 85 |
| Ex. 6 | Chemipearl S300 | 95 | 8.56 × 10⁶ | 7.85 × 10⁴ | 1.09 × 10² | 95 | 97 |
| Comp. | PVA-205 | 100 | 1.01 × 10⁷ | 7.89 × 10⁵ | 1.28 × 10 | 170 | 100 |
| Ex. 1 | | | | | | | |
| Comp. | R-1130 | 100 | 1.11 × 10⁷ | 8.81 × 10⁵ | 1.25 × 10 | 215 | 100 |
| Ex. 2 | | | | | | | |
| Comp. | REM-17 | 80 | 6.71 × 10⁶ | 3.14 × 10² | 2.14 × 10⁴ | 103 | 80 |
| Ex. 3 | | | | | | | |

TABLE 2
Physical Properties and Performance of Master

| | Physical properties of master | | | | Platemaking/printing performance | | |
|---|---|---|---|---|---|---|---|
| | Air | Average | | Basis | | Solid printed | Small |
| | permeability | pore size | Percent pore | weight | | area | character |
| | (sec) | (μm) | area (%) | (g/m²) | Pore blockage | uniformity | reproduction |
| Ex. 1 | 14 | 5.1 | 44.1 | 50 | A | A | A |
| Ex. 2 | 12 | 5.6 | 44.2 | 70 | A | A | A |
| Ex. 3 | 12 | 4.9 | 43.5 | 50 | A | A | A |
| Ex. 4 | 13 | 4.5 | 39.6 | 50 | A | A | A |
| Ex. 5 | 13 | 3.9 | 41.1 | 50 | A | A | A |
| Ex. 6 | 13 | 9.5 | 61.5 | 50 | A | A | A |
| Ex. 7 | 12 | 25 | 91.0 | 50 | B | B | B |
| Ex. 8 | 120 | 5.1 | 43.1 | 50 | A | B | A |
| Comp. | 14 | 4.4 | 38.2 | 50 | C | A | C |
| Ex. 1 | | | | | | | |
| Comp. | 13 | 4.9 | 38.1 | 50 | C | A | C |
| Ex. 2 | | | | | | | |
| Comp. | 14 | 5.5 | 50.2 | 50 | A | A | C |
| Ex. 3 | | | | | | | |

As is clear from Table 2, the Examples gave plates having excellent pore blockage, solid printed area uniformity, and reproduction of small characters.

This application is based upon and claims the benefit of priority from prior Japanese Patent Application No. 2003-123851, filed on Apr. 28, 2003; the disclosure of which is expressly incorporated herein by reference in its entirety.

It is to be noted that, besides those already mentioned above, many modifications and variations of the above embodiments may be made without departing from the novel and advantageous features of the present invention. Accordingly, all such modifications and variations are intended to be included within the scope of the appended claims.

1. A stencil printing master comprising:
a porous fiber layer; and
a porous resin layer formed on one surface of the porous fiber layer, the porous resin layer comprising a thermoplastic resin having a ratio (G1/G2) of a storage modulus (G1) at 45° C. to a storage modulus (G2) at 180° C. of 1×10² to 1×10⁴, and a peak melting temperature by DSC of 50° C. to 150° C.

2. The stencil printing master according to claim 1, wherein the thermoplastic resin is at least one of an ionomer resin and an olefin resin.

3. The stencil printing master according to claim 1, wherein, in a case where the porous resin layer includes a resin other than the thermoplastic resin, the thermoplastic resin has a melting energy that is 70% or more of the total melting energy of all the resins.

4. The stencil printing master according to claim 1, wherein the master has a basis weight of 35 g/m² or more and an air permeability of 100 sec or less.

5. The stencil printing master according to claim 1, wherein the average pore size of pores on the surface of the porous resin layer is 2 μm to 10 μm and the proportion of the area occupied by the pores is 30% to 90%.

6. The stencil printing master according to claim 1, wherein the master includes as a mold-release agent a silicone surfactant having an HLB value of at least 5.

7. The stencil printing master according to claim 1, wherein it is used for stencil printing employing an ink having a viscosity of 0.001 to 1 Pa·s.

8. A process for producing a stencil printing master according to claim 1, the process comprising:
(1) preparing a coating solution comprising a thermoplastic resin having a ratio (G1/G2) of a storage modulus (G1) at 45° C. to a storage modulus (G2) at 180° C. of 1×10² to 1×10⁴, and a peak melting temperature by DSC of 50° C. to 150° C.;
(2) introducing air bubbles into the coating solution by a mechanical stirring method; and
(3) coating one surface of a porous fiber layer with the air bubble-containing coating solution so as to form a porous resin layer.
